(19) United States
(12) Patent Application Publication
(10) Pub. No.: US 2025/0180845 A1
(43) Pub. Date: Jun. 5, 2025

(54) MOUNTING SYSTEM FOR REVERSIBLE CASSETTE

(71) Applicant: BELDEN CANADA ULC, Saint-Laurent (CA)

(72) Inventors: Lucas RAKOTO-SAM, Montréal (CA); Simon LYONNAIS-BOURQUE, Montreal (CA); Dwayne CRAWFORD, Pointe-Claire (CA)

(73) Assignee: BELDEN CANADA ULC, Saint-Laurent, QC (CA)

(21) Appl. No.: 19/045,431

(22) Filed: Feb. 4, 2025

Related U.S. Application Data
(63) Continuation of application No. 17/932,484, filed on Sep. 15, 2022, now Pat. No. 12,216,320.
(60) Provisional application No. 63/261,220, filed on Sep. 15, 2021.

(51) Int. Cl. G02B 6/44

(52) U.S. Cl. CPC G02B 6/4455

(57) ABSTRACT

A reversible fiber optic cassette is disclosed for mounting in one of a first orientation and a second reversed orientation on a tray a plurality of stabilizing slots. At least one stabilizing member is held within a respective aperture in a cassette bottom such that an L-shaped slot engaging portion extends above the first surface and a second L-shaped slot engaging portion extends above the second surface. Each of the second L-shaped slot engaging portions engages with a respective one of the stabilizing slots when the cassette is on the tray in the first orientation and each of the first slot engaging portions engages with a respective one of the stabilizing slots when the cassette is on the tray in the second reversed orientation.

### CROSS REFERENCE TO RELATED APPLICATIONS

This Application is a continuation of 17/932,484, filed Sep. 15, 2022, which claims priority under 35 USC § 119(e) of U.S. provisional application Ser. No. 63/261,220 filed on Sep. 15, 2021, which are incorporated herein in their entireties by reference.

### FIELD OF THE INVENTION

The present invention relates to a mounting system for reversible cassette.

### BACKGROUND TO THE INVENTION

The prior discloses reversible cassettes for mounting on a tray. One drawback of these prior art cassettes is that they are typically manufactured from plastic using an injection molding process and difficult to mold.

### SUMMARY OF THE INVENTION

The present provides a reversible fiber optic cassette for mounting in one of a first orientation and a second reversed orientation in a rack comprising a cassette receiving tray, the tray comprising a plurality of stabilizing slots. The cassette comprises a cassette body comprising a bottom comprising a first surface and a second surface, at least one stabilizing member held within a respective aperture in the bottom and such that a first L-shaped slot engaging portion of each of the stabilizing members extends above the first surface and a second L-shaped slot engaging portion of each of the stabilizing members extends above the second surface, each of the second L-shaped slot engaging portions for engaging with a respective one of the stabilizing slots when the cassette is on the tray in the first orientation and such that the tray is between an outer end of the second L-shaped slot engaging portions and the second surface and each of the first slot engaging portions for engaging with a respective one of the stabilizing slots when the cassette is on the tray in the second reversed orientation and such that the tray is between an outer end of the first L-shaped slot engaging portion and the first surface.

There is also provided a fiber optic cassette for mounting in one of a first orientation and a second reversed orientation in a rack comprising a cassette receiving tray, the tray comprising a plurality stabilizing slots. The cassette comprises a cassette body comprising a bottom comprising a first surface and a second surface, at least one stabilising member comprising a flat first part, a flat second part and a flat third part comprising a pair of opposed edges, each of the flat first part and the flat second part interconnected at right angles to a respective one of the opposed edges and such that each of the first part and the second part extend away from the third part in opposite directions. The stabilising member is secured within a respective aperture in the bottom and such that the first part is arranged a first distance above and in parallel to the first surface, the flat second part is arranged a second distance below and in parallel to the second surface and the third part intersects the bottom at right angles.

### BRIEF DESCRIPTION OF THE DRAWINGS

FIG. 1 provides a right raised perspective view of a reversible cassette and tray in accordance with an illustrative embodiment of the present invention;

FIG. 2A provides an exploded raised right front perspective view of a cassette in accordance with an illustrative embodiment of the present invention;

FIG. 2B provides an exploded lower right front perspective view of a cassette in accordance with an illustrative embodiment of the present invention;

FIG. 2C provides a sectional view along line IIC-IIC in FIG. 1;

FIG. 2D provides a in accordance with an illustrative embodiment of the present invention;

FIG. 3A provides a sectional view along line IIIA-IIIA in FIG. 2A;

FIG. 3B provides a sectional view along line IIIB-IIIB in FIG. 1;

FIG. 4A provides a raised right front perspective view of a cassette in accordance with a second illustrative embodiment of the present invention;

FIG. 4B provides a sectional view along line IVB-IVB in FIG. 4A;

FIG. 5A provides a raised right front perspective view of a cassette in accordance with a third illustrative embodiment of the present invention; and

FIG. 5B provides a sectional view along line VB-VB in FIG. 5A.

### DETAILED DESCRIPTION OF THE ILLUSTRATIVE EMBODIMENTS

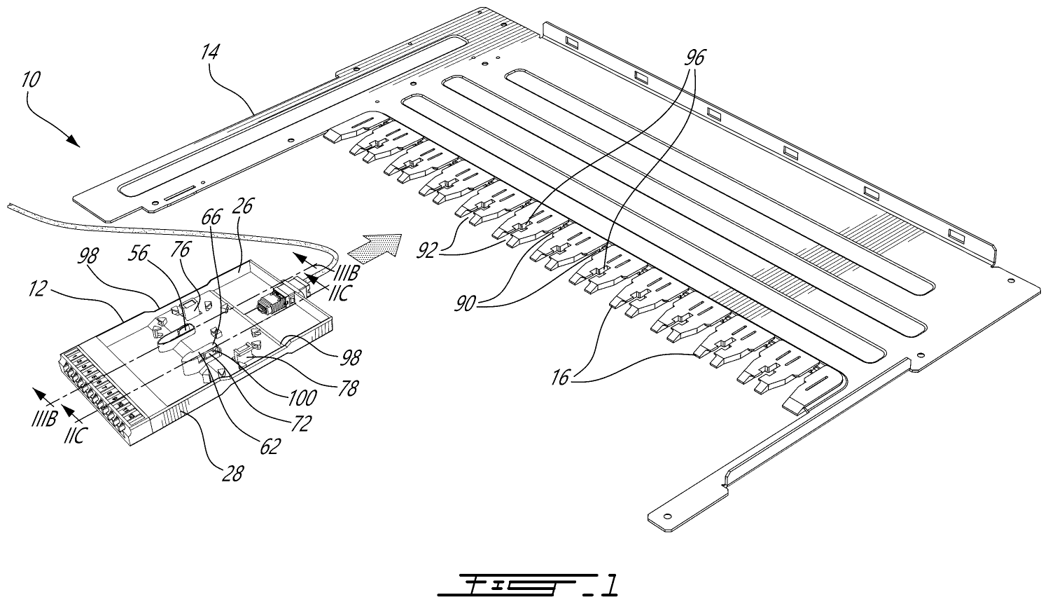

Referring now to FIG. 1, a reversible cassette and system, generally referred to using the reference numeral 10, will now be described. The cassette and system 10 comprises one or more cassettes 12 which are releasably mounted to a tray 14 comprising a plurality of cassette engaging features 16. The tray 14 is typically slideably mounted with other trays in a case which is dimensioned for securing in a 19″ inch rack or the like (both not shown).

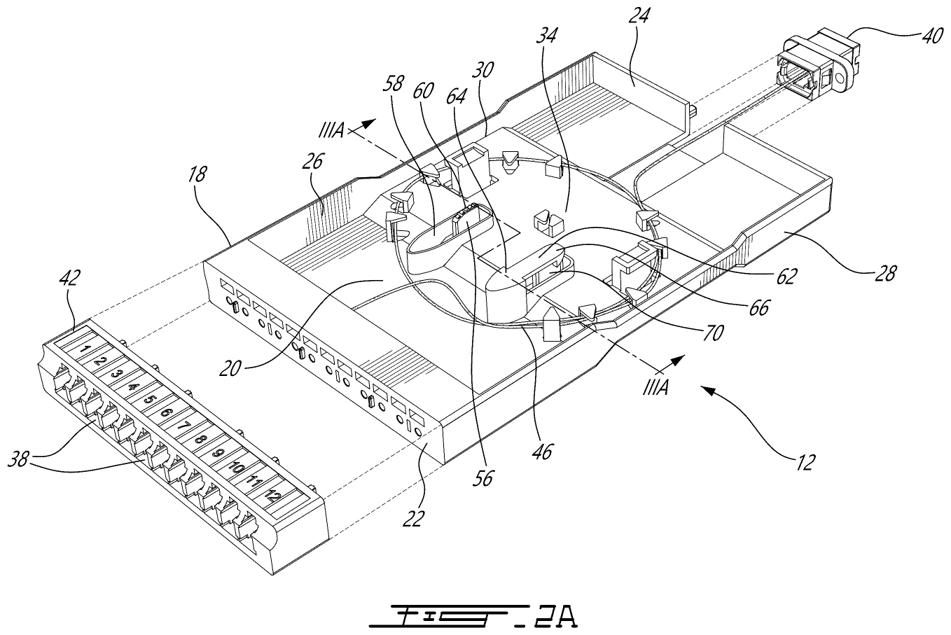

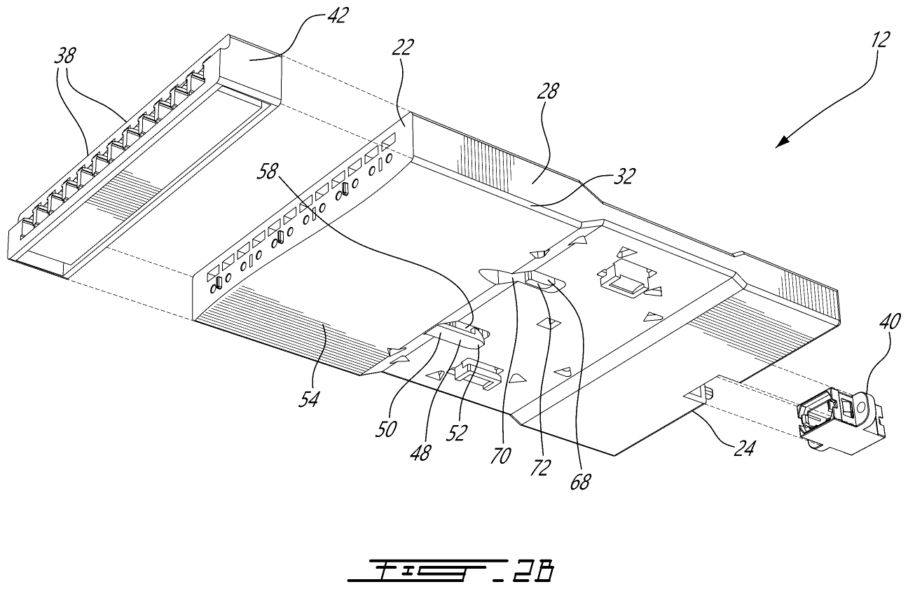

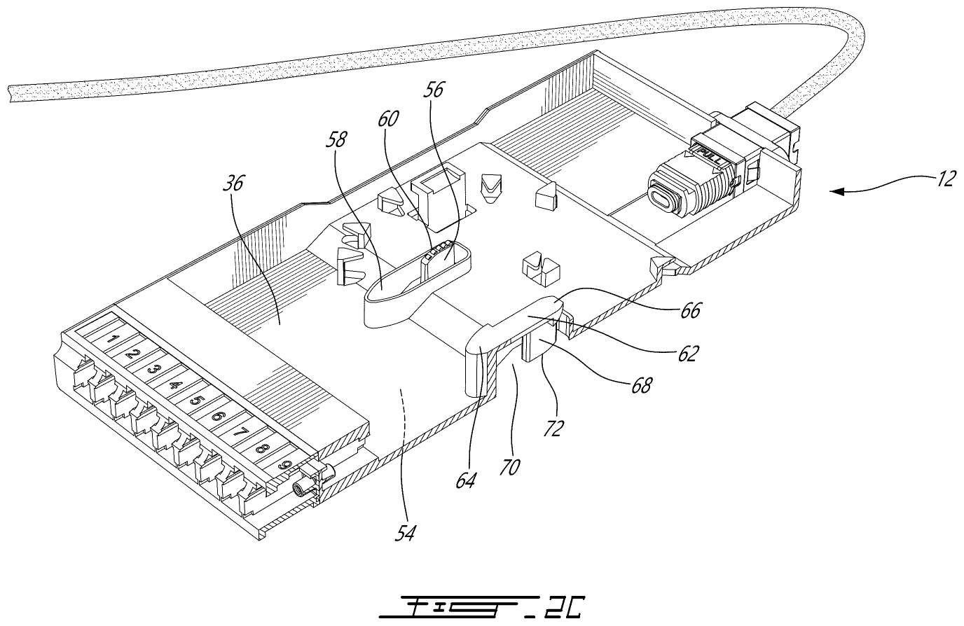

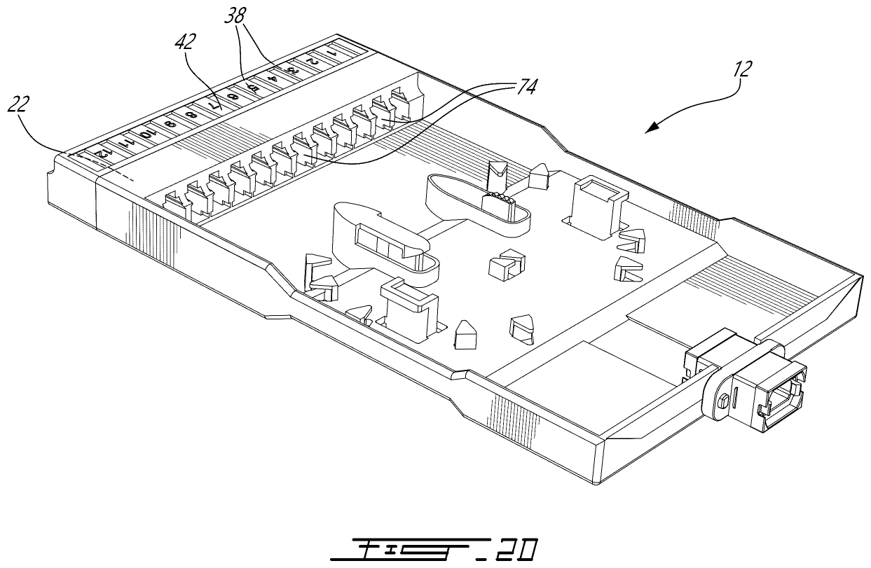

Referring now to FIGS. 2A and 2B, in a first embodiment each cassette 12 comprises a cassette body 18 comprising a bottom 20 and front 22 and back 24 opposite the front and interconnected by a pair of opposed side edges 26, 28 which run along respective outer edges 30, 32 of the bottom 20. The bottom 20, front 22, back 24 and opposed side edges 26, 28 together define a cable receiving region 34 above a first surface 36 of the bottom 20. A plurality of optic fiber receptacles 38 are arranged along the front 22 of the cassette body 18 and illustratively a multifiber receptacle 40 is arranged along the back 24. In one embodiment the optic fiber receptacles 38 are molded or otherwise formed as a block 42 mountable to the front 22 of the cassette body 18, for example using mechanical interlock, ultrasonic welding or an adhesive or the like. The receptacles 38 are configured for receiving a standard LC type plug for example terminating a single fiber optic cable or the like (both not shown). Additionally, the spacing between the optic fiber receptacles 38 is such that any two optic fiber receptacles 38 can receive two plugs (also not shown) in a duplex configuration. In one embodiment the multi fiber receptacle 40 is configured for receiving a standard MPO type plug terminating a 12× multi-fiber cable or the like (both not shown).

Still referring to FIGS. 2A and 2B, the cable receiving region 34 comprises a plurality of cable retaining features 44 arranged on the first surface 36 of the bottom 20 along a generally circular path to receive and retain a plurality of optic fiber segments 46.

Referring back to FIG. 1 in addition to FIGS. 2A and 2B, a tray engaging feature 48 positioned in an aperture and comprising a fixed end 50 connected to an inner edge/surface of the aperture and a flexible end 52 by a flexible member is provided that extends beyond a second surface 54 of the bottom 20 and is configured for engaging with one of the plurality of cassette engaging features 16 when the cassette 12 is arranged on the tray 14 in a first orientation. The flexible member biases the flexible end 52 into a normally engaged position.

Referring to FIG. 2C in addition to FIGS. 1, 2A and 2B, in a first embodiment of the cassette 12, a first actuator 56 is further provided which extends from the flexible end 52 through an aperture 58 in the bottom 20. As a person of ordinary skill in the art will now understand, the actuatable surface 60 of the first actuator 56 is accessible from the side of the first surface 36 of the cassette 12 when the cassette 12 is installed in a first orientation on the tray 14.

Still referring to FIGS. 1, 2A, 2B and 2C, in the first embodiment of the cassette 12, a second tray engaging feature 62 also comprising a fixed end 64 and a flexible end 66 is also provided extending above the first surface 36 of the bottom 20 and is configured for engaging with one of the plurality of cassette engaging features 16 when the cassette 12 is arranged on the tray 14 in a second reversed orientation. In the first embodiment of the cassette 12, a second actuator 68 is further provided which extends from the flexible end 66 through an aperture 70 in the bottom 20. As a person of ordinary skill in the art will now understand, an actuatable surface 72 of the second actuator 68 is accessible from the side of the second surface 54 of the cassette 12 when the cassette 12 is installed in a second reversed orientation on the tray 14.

Referring now to FIG. 2D in addition to FIG. 2A, as discussed above in one embodiment the receptacles 38 are molded together as a block 42, illustratively a block 42 of twelve (12) LC type receptacles. Similarly, an inside of the front 22 of the cassette body 18 comprises a plurality of receptacles 74 molded or otherwise formed therein. In one embodiment, the receptacles 74 are configured for receiving a standard LC type plug (not shown) for example terminating a single fiber optic cable (reference 46 in FIG. 2A) or the like. As discussed above, the block 42 of receptacles 38 is attached to the front 22, for example by sonic welding, a suitable adhesive or the like and such that the receptacles 38 align with the receptacles 74, with each receptacle 38/receptacle 74 pair acting as a coupler assembly interconnecting optic fibers (not shown) terminated at each receptacle 38, 74 pair and such that the ferrules (not shown) of each pair of terminated optic fibers are arranged along the same axis.

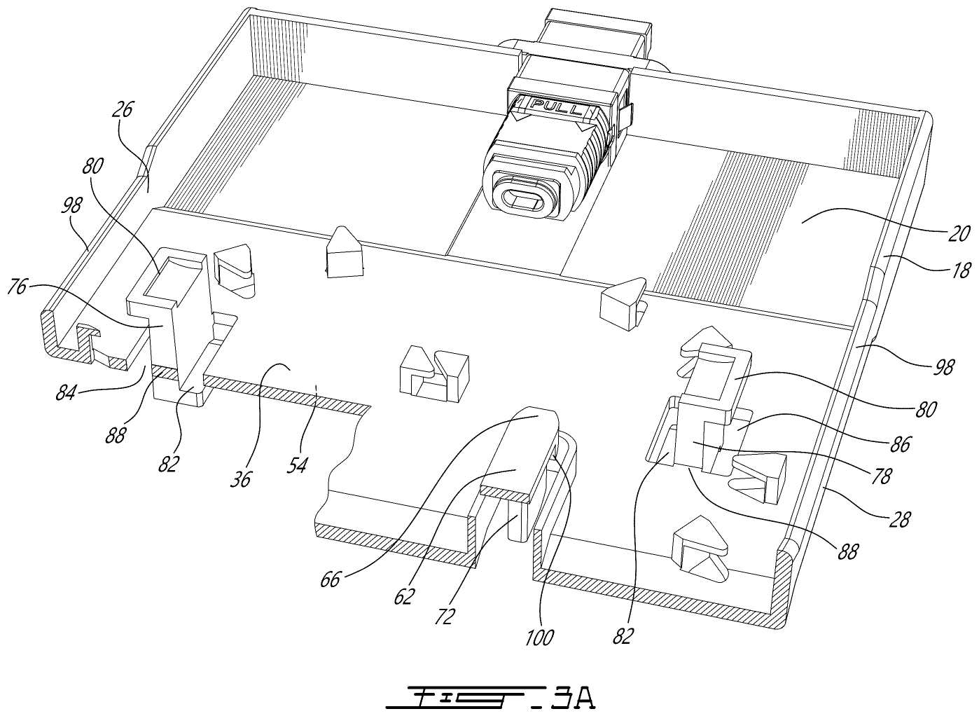

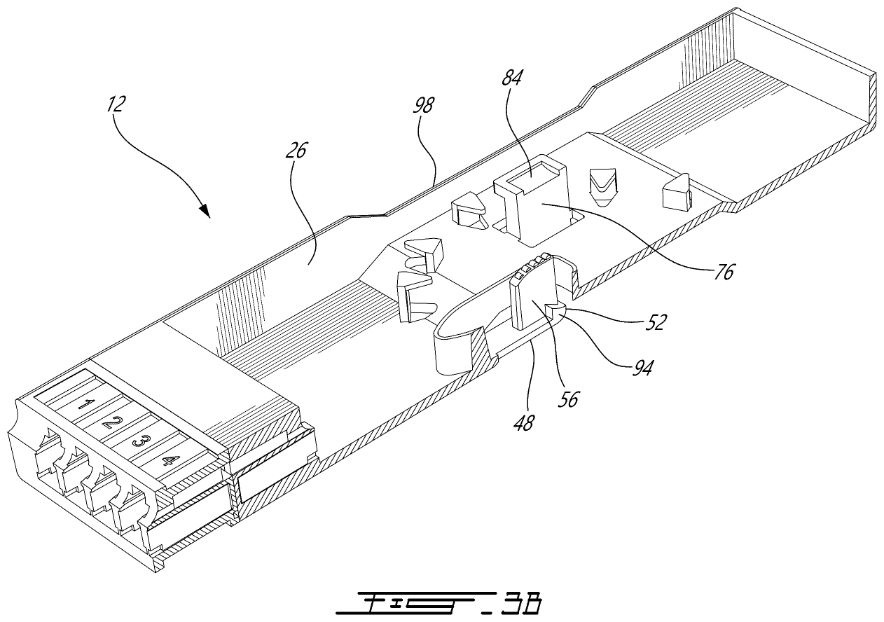

Referring now to FIG. 3A, in order to stabilize the cassette 12 when it is on the tray 14 a pair of stabilizing members 76, 78 are provided. Each member 76, 78 comprises a first L shaped slot engaging portion 80 which extends beyond the first surface 36 of the bottom 20 of the cassette body 18 and a second L shaped slot engaging portion 82 which extends beyond the second surface 54 of the bottom 20 of the cassette body 18. Each stabilizing member 76 is illustratively positioned within a respective aperture 84, 86. A flat center portion 88 of each of the stabilizing members 76, 78 is secured to the cassette body 18 within their respective apertures 84, 86.

Referring to FIGS. 1 and 3B in addition to FIG. 3A, on insertion of the cassette 12 onto the cassette engaging features 16 in the first orientation, the stabilising members 76, 78 are engaged within respective ones of a plurality of spaces 90 provided in the strip 18 between each of the cassette engaging features 16 and such that the tray 14 is held between each second L shaped slot engaging portion 82 and the second surface 54 of the bottom 20 of the cassette body 18. Additionally, on insertion of the cassette 12 onto the cassette engaging features 16 in the first orientation the actuator 56 is slid into a slot 92 in the selected cassette engaging feature 16 and a hook 94 on the flexible end 52 of the tray engaging feature 48 moves into an aperture 96 in the cassette engaging feature 16. A person of ordinary skill in the art will now understand that the hook 94 is biased into the aperture 96 by the flexible end 52 and such that the cassette 12 is securely held to the tray 14. Similarly, in order to release the cassette 12 from the tray 14, the actuator 56 is depressed thereby biassing the hook 94 out of the aperture 96 in the cassette engaging feature 16 thereby allowing the cassette 12 in the first orientation to be retracted from the tray 14.

Still referring to FIGS. 1 and 3A and 3B, a person of ordinary skill in the art will understand that on insertion of the cassette 12 onto the cassette engaging features 16 in the second orientation, the stabilising members 76, 78 are engaged within respective ones of a plurality of spaces 90 provided in the strip 18 between each of the cassette engaging features 16 and such that the tray 14 is held between each second L shaped slot engaging portion 82 and the upper edge 98 of the outer edges 26, 28. Additionally, on insertion of the cassette 12 onto the cassette engaging features 16 in the second orientation the actuator 72 is slid into the slot 92 in the selected cassette engaging feature 16 and a hook 100 on the flexible end 66 of the tray engaging feature 62 moves into the aperture 96 in the cassette engaging feature 16. As discussed above, the hook 100 is biased into the aperture 96 by the flexible end 66 and such that the cassette 12 is securely held to the tray 14. Similarly, in order to release the cassette 12 from the tray 14, the actuator 72 is depressed thereby biassing the hook 100 out of the aperture 96 in the cassette engaging feature 16 thereby allowing the cassette 12 in the second orientation to be retracted from the tray 14.

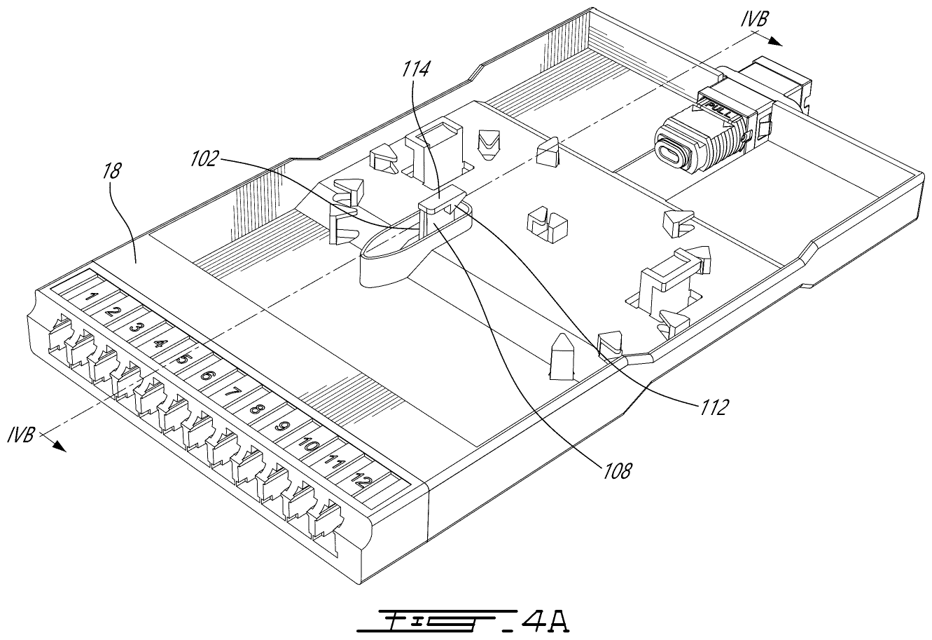

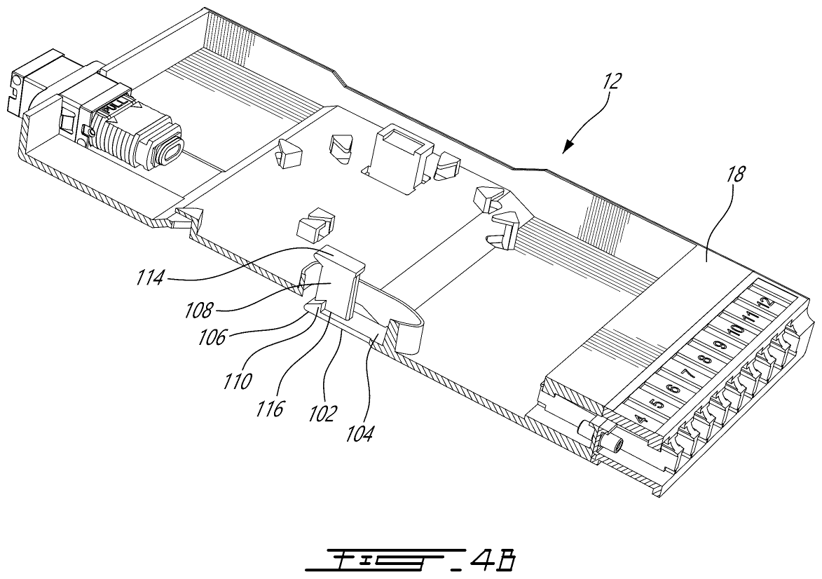

Referring now to FIGS. 4A and 4B, in a second illustrative embodiment of a cassette 12, a two-way tray engaging feature 102 is provided. The two-way tray engaging feature 102 comprises a fixed part 104 secured to the cassette body 18 and a flexible part 106. An actuator 108 is provided on the flexible part 106 which comprises a first hook 110 and a second hook 112, one at each end of the actuator 108. The outer surfaces of the of hooks 110, 112 respectively act as a first actuating surface 114 and a second actuating surface 116 and such that pressing against one or other of the actuating surfaces 114, 116 caused the actuator 108 to bend the flexible part 106 against its own bias.

Referring back to FIG. 1 in addition to FIGS. 4A and 4B, as a person of ordinary skill in the art will now understand, on insertion of the cassette 12 onto the cassette engaging features 16 in the first orientation, the actuator 108 is slid into a slot 92 in the selected cassette engaging feature 16 and the first hook 110 on the flexible end 106 of the tray engaging feature 102 moves into an aperture 96 in the cassette engaging feature 16. The first hook 110 is biased into the aperture 96 by the flexible end 106 and such that the cassette 12 is securely held to the tray 14. Similarly, in order to release the cassette 12 from the tray 14, the first actuator surface 114 is pressed thereby biassing the first hook 110 out of the aperture 96 in the cassette engaging feature 16 and allowing the cassette 12 in the first orientation to be retracted from the tray 14. Similarly, on insertion of the cassette 12 onto the cassette engaging features 16 in the second orientation, the actuator 108 is slid into a slot 92 in the selected cassette engaging feature 16 and the second hook 112 on the flexible end 106 of the tray engaging feature 102 moves into an aperture 96 in the cassette engaging feature 16. The second hook 112 is biased into the aperture 96 by the flexible end 106 and such that the cassette 12 is securely held to the tray 14. Similarly, in order to release the cassette 12 from the tray 14, the second actuator surface 116 is pressed thereby biassing the second hook 112 out of the aperture 96 in the cassette engaging feature 16 and allowing the cassette 12 in the first orientation to be retracted from the tray 14.

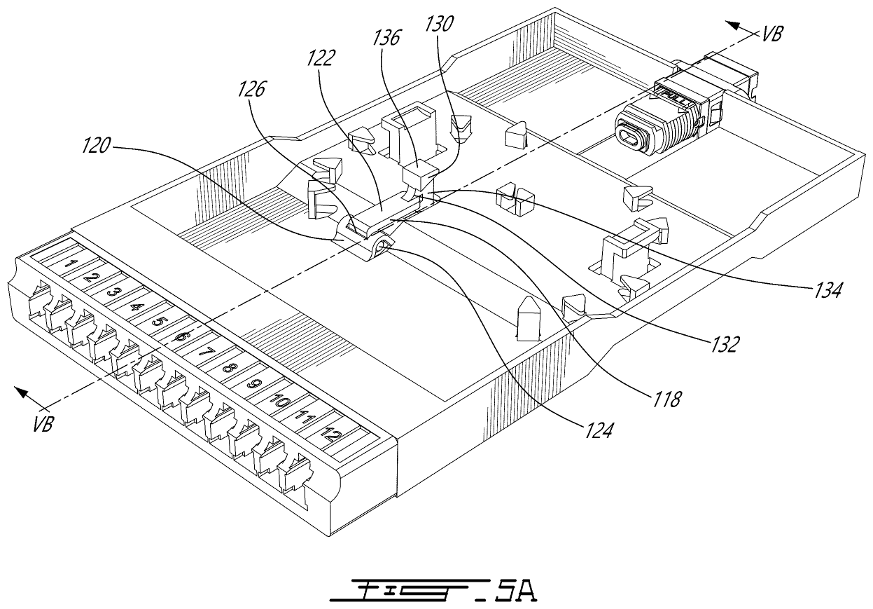

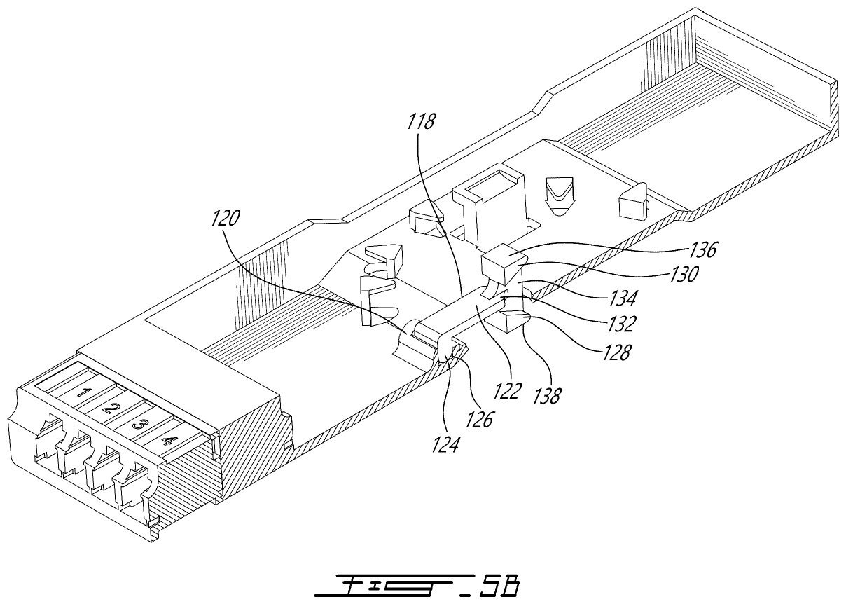

Referring now to FIGS. 5A and 5B, in a third illustrative embodiment of a cassette 12, an two-way tray engaging assembly 118 is provided. The two-way tray engaging assembly 118 comprises a fixed part 120 moulded or otherwise formed in the cassette body 18 and a lever part 122. A barrel-shaped fixed end 124 of the lever part 122 is snap fit into a slot 126 in the fixed part 120. A first tray engaging part 128 and a second tray engaging part 130 are also provided arranged opposite one another at a flexible end 132 of the lever part 122 and spaced by an interconnecting part 134 connected to the flexible end 132 and arranged at right angles to the lever part 122. The outer surfaces of the first tray engaging part 128 and a second tray engaging part 130 respectively act as a first actuating surface 136 and a second actuating surface 138 and such that pressing against one or other of the actuating surfaces 136, 138 causes the lever part 122 to bend against its own bias.

Referring back to FIG. 1 in addition to FIGS. 5A and 5B, as a person of ordinary skill in the art will now understand, on insertion of the cassette 12 onto the cassette engaging features 16 in the first orientation, the interconnecting part 134 is slid into a slot 92 in the selected cassette engaging feature 16 and the first tray engaging part 128 on the flexible end 132 of the lever part 122 moves into an aperture 96 in the cassette engaging feature 16. The first tray engaging part 128 is biased into the aperture 96 by the unbending of the lever part 122 and such that the cassette 12 is securely held to the tray 14. Similarly, in order to release the cassette 12 from the tray 14, the first actuating surface 136 is pressed thereby biassing the first tray engaging part 128 out of the aperture 96 in the cassette engaging feature 16 and allowing the cassette 12 in the first orientation to be retracted from the tray 14. Similarly, on insertion of the cassette 12 onto the cassette engaging features 16 in the second orientation, the interconnecting part 134 is slid into a slot 92 in the selected cassette engaging feature 16 and the second tray engaging part 130 on the flexible end 132 of the lever part 122 moves into an aperture 96 in the cassette engaging feature 16. The second tray engaging part 130 is biased into the aperture 96 by the unbending of the lever part 122 and such that the cassette 12 is securely held to the tray 14. Similarly, in order to release the cassette 12 from the tray 14, the second actuating surface 138 is pressed thereby biassing the second tray engaging part 130 out of the aperture 96 in the cassette engaging feature 16 and allowing the cassette 12 in the first orientation to be retracted from the tray 14.

Although the present invention has been described hereinabove by way of specific embodiments thereof, it can be modified, without departing from the spirit and nature of the subject invention as defined in the appended claims.

1. A fiber optic cassette structurally configured to be mounted in one of a first orientation and a second reversed orientation on a cassette receiving tray, comprising:
a cassette body portion comprising a bottom portion comprising a first surface portion and a second surface portion;
a stabilizing disposed in a respective aperture in the bottom portion;
wherein the stabilizing portion includes a first slot engaging portion configured to extend beyond the first surface portion and a second slot engaging portion configured to extend beyond the second surface portion;
wherein the second slot engaging portion is structurally configured to engage with a stabilizing slot in a cassette receiving tray when the cassette is on the tray in the first orientation and such that the tray is between an outer end portion of the second slot engaging portion and the second surface portion, and the first slot engaging portion is structurally configured to engage with a stabilizing slot in the cassette receiving tray when the cassette is on the tray in the second reversed orientation and such that the tray is between an outer end portion of the first slot engaging portion and the first surface portion.

2. The fiber optic cassette of claim 1, wherein the tray portion further comprises a plurality of cassette engaging features, the cassette further comprising a first tray engaging feature extending above the second surface portion and structurally configured to engage with one of the cassette engaging features when the cassette is on the tray in the first orientation, a second tray engaging feature extending above the first surface portion and structurally configured to engage with one of the cassette engaging features when the cassette is on the tray in the second reversed orientation, and an actuator portion configured to selectively disengage the first tray engaging feature and the second tray engaging feature from an engaged one of the cassette engaging features.

3. The fiber optic cassette of claim 2, further comprising a biasing portion structurally configured to bias each of the tray engaging features into a normally engaged position and further wherein the actuator portion works against the biasing.

4. The fiber optic cassette of claim 3, wherein the biasing portion comprises a plurality of flexible members, wherein each of the tray engaging features is positioned within a respective one of a plurality of second apertures in the bottom portion, and wherein a respective one of the flexible members is positioned between each of the tray engaging features and an inner surface portion of the respective one of the second apertures.

5. The fiber optic cassette of claim 4, wherein the first tray engaging feature and the second tray engaging feature are positioned at opposite ends of an interconnecting part and further wherein the interconnecting part is positioned within a second aperture in the bottom.

6. The fiber optic cassette of claim 5, wherein the flexible member is interconnected between an inner edge of the aperture and the interconnecting part.

7. The fiber optic cassette of claim 2, further comprising a pair of the first tray engaging features and a pair of the second tray engaging features.

8. The fiber optic cassette of claim 1, wherein the cassette body portion further comprises a front portion and a back portion opposite the front portion, wherein the bottom portion, the front portion, and the back portion are configured to define a cable receiving region above the first surface portion and further comprising a plurality of optic fiber receptacles arranged along the front portion of the cassette body portion, a multifiber receptacle along the back portion of the cassette body portion; and a plurality of optic fiber segments, each of the segments arranged within the cable receiving region between a respective one of the optic fiber receptacles and the multifiber receptacle.

9. The fiber optic cassette of claim 8, further comprising a plurality of cable retaining features on the first surface portion within the cable receiving region and arranged along a generally circular path.

10. A fiber optic cassette structurally configured to be mounted in one of a first orientation and a second reversed orientation on a cassette receiving tray, comprising:
a cassette body portion comprising a bottom portion comprising a first surface portion and a second surface portion;
a stabilizing portion comprising a flat first part, a flat second part, and a flat third part comprising a pair of opposed edges;
wherein each of the flat first part and the flat second part is configured to be interconnected at right angles to a respective one of the opposed edges and such that each of the first part and the second part extend away from the third part in opposite directions;
wherein the stabilizing member is secured within a respective aperture in the bottom portion such that the first part is arranged a first distance above and in parallel to the first surface portion, the flat second part is arranged a second distance below and in parallel to the second surface portion and the third part intersects the bottom portion at right angles.

11. The fiber optic cassette of claim 10, wherein the third flat part is elongate and the pair of opposed edges comprise a pair of opposed short edges.

12. The fiber optic cassette of claim 10, wherein the first distance is greater than the second distance.

13. The fiber optic cassette of claim 10, wherein the fiber optic cassette further comprises a first tray engaging feature extending above the second surface portion and configured to engage with a cassette engaging feature of a tray when the cassette is on the tray in the first orientation, a second tray engaging feature extending above the first surface portion and configured to engage with a cassette engaging feature of the tray when the cassette is on the tray in the second reversed orientation, and an actuator portion configured to selectively disengage the first tray engaging feature and the second tray engaging feature from an engaged one of the cassette engaging features.

14. The fiber optic cassette of claim 13, further comprising a biasing portion configured to bias each of the tray engaging features into a normally engaged position and further wherein the actuator works against the biasing.

15. The fiber optic cassette of claim 14, wherein the biasing portion comprises a plurality of flexible members, wherein each of the tray engaging features is positioned within a respective one of a plurality of second apertures in the bottom portion, and wherein a respective one of the flexible members is positioned between each of the tray engaging features and an inner surface portion of the respective one of the apertures.

16. The fiber optic cassette of claim 15, wherein the first tray engaging and the second tray engaging feature are positioned at opposite ends of an interconnecting part and further wherein the interconnecting part is positioned within a second aperture in the bottom portion.

17. The fiber optic cassette of claim 16, wherein the flexible member is interconnected between an inner edge of the aperture and the interconnecting part.

18. The fiber optic cassette of claim 2, further comprising a pair of the first tray engaging features and a pair of the second tray engaging features.

19. The fiber optic cassette of claim 10, wherein the cassette body portion further comprises a front portion and a back portion opposite the front portion, wherein the bottom portion, the front portion, and the back portion are configured to define a cable receiving region above the first surface portion and further comprising a plurality of optic fiber receptacles arranged along the front portion of the cassette body portion, a multifiber receptacle along the back portion of the cassette body portion; and a plurality of optic fiber segments, each of the segments arranged within the cable receiving region between a respective one of the optic fiber receptacles and the multifiber receptacle.

20. The fiber optic cassette of claim 19, further comprising a plurality of cable retaining features on the first surface portion within the cable receiving region and arranged along a generally circular path.
